(19) United States
(12) Patent Application Publication
(10) Pub. No.: US 2026/0258556 A1
(43) Pub. Date: Sep. 3, 2026

(54) ULTRAFAST HIGH TEMPERATURE SINTERING (UHS) SYSTEMS AND METHODS FOR FABRICATING ENVIRONMENTAL-THERMAL BARRIER COATINGS

(71) Applicants: UNIVERSITY OF MARYLAND, COLLEGE PARK, College Park, MD (US); PRESIDENT AND FELLOWS OF HARVARD COLLEGE, Cambridge, MA (US)

(72) Inventors: Liangbing HU, Woodbridge, CT (US); Hua XIE, Hyattsville, MD (US); Ji-Cheng ZHAO, Dublin, OH (US); Wei ZHONG, College Park, MD (US); David CLARKE, Cambridge, MA (US); Victor CHAMPAGNE, Dudley, MA (US)

(21) Appl. No.: 18/878,638

(22) PCT Filed: Jun. 30, 2023
(86) PCT No.: PCT/US2023/026765

§ 371 Date: Dec. 23, 2024

Related U.S. Application Data
(60) Provisional application No. 63/358,063, filed on Jul. 1, 2022.

(51) Int. Cl. C23C 24/08; C04B 41/00; C04B 41/45; C04B 41/87; C04B 41/89; F01D 5/28

(52) U.S. Cl. CPC C23C 24/085; C04B 41/009; C04B 41/4558; C04B 41/87; C04B 41/89; F01D 5/288; F05D 2220/32; F05D 2230/22; F05D 2240/35

(57) ABSTRACT

One or more precursors can be provided over a surface of a component. A heating element can be provided over the one or more precursors such that the heating element substantially conforms to a shape of the component surface. The precursor(s) can be sintered to form a layer of an environmental-thermal barrier (ETB) coating by subjecting the precursor(s) to a temperature of 500-3273 K for a duration of 10 minutes or less. The temperature can be generated by passing an electric current through the heating element to cause Joule heating of the heating element.

### CROSS-REFERENCE TO RELATED APPLICATIONS

The present application claims the benefit of U.S. Provisional Application No. 63/358,063, filed Jul. 1, 2022, entitled “Design, Fabrication and Use of Environmental-thermal Barrier Coatings by Ultrafast High Temperature Sintering,” which is hereby incorporated by reference herein in its entirety.

### STATEMENT REGARDING FEDERALLY SPONSORED RESEARCH

This invention was made with government support under DEAR0001424 awarded by the U.S. Department of Energy, Advanced Research Projects Agency-Energy (DOE-ARPA-E). The government has certain rights in the invention.

### FIELD

The present disclosure relates generally to component coatings, and more particularly, to systems and methods for fabricating coatings via ultrafast high temperature sintering (UHS), such as environmental-thermal barrier (ETB) coatings.

### BACKGROUND

Environmental-thermal barrier (ETB) coatings are used to protect components in high-temperature environments from corrosion and oxidation, such as components of gas turbines, jet engines, or industrial applications that will be exposed to high temperatures and/or corrosive gases. With gas-turbine engines, further improvements in energy efficiency and the thrust-to-weight ratio may require the development of new ETB coatings capable of operating at higher temperatures (e.g., ≥1300° C., such as ≥1700° C.). Such new ETB coatings should meet a series of requirements at higher temperature, such as low thermal conductivity, high thermal stability, and a close match of the coefficient of thermal expansion (CTE) to that of the underlying substrate (e.g., alloy, such as a superalloy). However, existing ETB coatings, such as yttria-stabilized zirconia (YSZ) deployed on Ni-based superalloys and similar coatings on SiC/SiC ceramic matrix composites (CMCs), have temperature capabilities far below 1700° C.

In conventional fabrication processes, ETB coatings are deposited by air plasma-spraying (APS) or by electron-beam physical vapor deposition (EBPVD). However, such conventional fabrication processes require expensive equipment, which can make the discovery of new ETB coatings using such processes cost prohibitive. Moreover, conventional fabrication processes may be limited in their ability to form certain coatings. For example, the α-alumina phase, which is the most stable high-temperature phase for alumina, cannot be directly deposited by APS or EBPVD method. Conventional fabrication processes may also be unable to deposit composite coatings with mixed oxides or two-phase oxides, which coatings may have a CTE match with a particular substrate or other physical attributes that is more desirable than that of single phase coatings. Spark plasma sintering (SPS), which can be used to sinter a dense coating, can be difficult to apply to non-planar or contoured surfaces (e.g., components with curvature).

Embodiments of the disclosed subject matter may address one or more of the above-noted problems and disadvantages, among other things.

### SUMMARY

Embodiments of the disclosed subject matter can form coatings via ultrafast high-temperature sintering (UHS) and can provide components with such coatings. In some embodiments, UHS can involve heating at a high temperature (e.g., 500 K or greater, such as at least 1500 K) for a short duration (e.g., 10 minutes or less, such as 10 seconds to 2 minutes) to convert one or more precursors (e.g., powder) on a surface of a component (e.g., turbine blade, combustor, etc.) into one or more layers (e.g., sintered layers) for a coating (e.g., an environmental-thermal barrier (ETB) coating), without thermal degradation of the underlying component. For example, the UHS can be provided by one or more Joule heating elements. In some embodiments, the component surface can be non-planar or contoured (e.g., curved or having adjacent portions at an angle that would otherwise be difficult to coat). The heating element can be sufficiently flexible to conform to the shape of the component surface. Alternatively, in some embodiments, the heating element can be a layer conformally formed on or over the one or more precursors. After UHS, the conformal layer can be removed, for example, by heating in an oxygen atmosphere to burn off the conformal layer.

In one or more embodiments, a method can comprise providing one or more first precursors over a surface of a component to be coated and providing a heating element over the one or more first precursors. The heating element can substantially conform to a shape of the component surface. The method can further comprise sintering the one or more first precursors to form a first layer of an ETB coating over the component surface by subjecting the one or more first precursors to a sintering temperature in a range of 500-3273 K, inclusive, for a duration of less than or equal to 10 minutes. The sintering temperature can be generated by passing an electric current through the heating element to cause Joule heating thereof.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of an exemplary component with a coating formed thereon via ultrafast high temperature sintering (UHS), according to one or more embodiments of the disclosed subject matter.

FIG. 1B is a simplified cross-sectional view of a UHS-formed coating with a single layer, according to one or more embodiments of the disclosed subject matter.

FIGS. 1C-1F are simplified cross-sectional views of multi-layer coatings formed via UHS, according to one or more embodiments of the disclosed subject matter.

FIG. 2A illustrates aspects of sequential UHS to form a multi-layer coating, according to one or more embodiments of the disclosed subject matter.

FIG. 2B illustrates aspects of a simultaneous UHS to form a multi-layer coating, according to one or more embodiments of the disclosed subject matter.

FIG. 2C illustrates aspects of UHS with simultaneous component cooling to form a coating, according to one or more embodiments of the disclosed subject matter.

FIG. 2D illustrates aspects of using an in situ heating element to form a coating via UHS, according to one or more embodiments of the disclosed subject matter.

FIG. 3A illustrates a process flow diagram for a method for fabrication and use of a coated component, according to one or more embodiments of the disclosed subject matter.

FIG. 3B depicts a generalized example of a computing environment in which the disclosed technologies may be implemented.

FIG. 4A is a cross-sectional view of a silicon carbide substrate having a bi-layer coating of barium strontium aluminum silicate (BSAS) and alumina.

FIG. 4B is a cross-sectional view of a C103 alloy substrate having a bi-layer coating of yttrium monosilicate (YMS) and niobium disilicide (NbSi₂).

FIG. 5A is a scanning electron microscopy (SEM) image of a two-phase oxide coating of yttria-stabilized zirconia (YSZ) and alumina, formed by sintering at 1800° C. for 10 seconds.

FIG. 5B is an SEM image of a two-phase oxide coating of YSZ and alumina, formed by sintering at 2500° C. for 10 seconds.

FIG. 5C shows an energy dispersive spectroscopy (EDS) mapping of a two-phase oxide coating of YSZ and alumina, formed by sintering at 2500° C. for 10 seconds.

FIG. 6A is a simplified cross-sectional view of an exemplary configuration for a periodic multilayer coating.

FIGS. 6B-6C are SEM images of an arrangement of precursors (tapes) for forming a periodic multilayer coating.

FIG. 6D is an SEM image of a formed periodic multilayer coating.

FIG. 7A shows X-ray diffraction (XRD) analysis of γ-alumina powder prior to UHS.

FIG. 7B shows XRD analysis of an α-alumina layer formed by UHS of the γ-alumina powder coating.

FIG. 8A is an image of blade-shaped substrates coated with a precursor tape of YMS after cold isostatic pressing (CIP) treatment.

FIG. 8B is an image of the coated blade-shaped substrates of FIG. 8A after calcination (200° C. for 0.5 hours, followed by 400° C. for 1.5 hours).

FIG. 8C shows sintering by a curved carbon felt heater to densify the YMS tape of the blade-shaped substrate of FIG. 8B.

FIG. 8D shows the final coated substrate after the sintering of FIG. 8C.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Ultrafast High-temperature Sintering (UHS) Period: Application of temperatures in a range of 500-3273 K, inclusive, for a duration less than or equal to 10 minutes. In some embodiments, the duration can be less than or equal to 5 minutes, for example, in a range of 10 seconds to 2 minutes, inclusive. In some embodiments, UHS may be repeated one or more times, with each repetition of the UHS having a duration in a predetermined range, for example, 10 seconds to 2 minutes, inclusive. Alternatively, in some embodiments, UHS can repeated as one or more pulses (e.g., application of temperatures in a range of 500-3273 K), with each pulse having a duration in a first predetermined range (e.g., less than 60 seconds, such as 1-10 seconds, inclusive). In some embodiments, the combined duration of such pulses can be in a second predetermined range (e.g., 10 seconds to 2 minutes, inclusive). In some embodiments, the duration of the UHS period may be defined by controlling operation of one or more heating elements, for example, by heating to and/or cooling from a peak temperature or temperatures in a range of 500-3273 K, inclusive. For example, the UHS may involve heating at a ramp rate of at least 10³ ° C./s (e.g., about 10³-10⁵ ° C./s), and/or cooling at a ramp rate of at least 10³ ° C./s (e.g., about 10³-10⁵ ° C./s). Alternatively or additionally, in some embodiments, the duration of the UHS period may be defined by moving one or more heating elements and/or a component subject to UHS, for example, such that a different portion of the component is exposed to heating by the one or more heating elements.

Sintering temperature: Temperature at a surface of one or more heating elements when energized (e.g., by application of a current pulse) and/or at a surface of a component being heated (e.g., precursor layer on a component). In some embodiments, the sintering temperature is at least 500 K (~227° C.), for example, at least 1000 K (~727° C.). In some embodiments, the sintering temperature is in a range of 1500 K (~1227° C.) to 3273 K (~3000° C.), inclusive. In some embodiments, the sintering temperature is temperature experienced by the material being sintered (e.g., precursor). In some embodiments, the temperature at a material being sintered (e.g., precursor) can match or substantially match (e.g., within 10%) the temperature of at least one heating element. In some embodiments, the sintering temperature is not static (e.g., varies) during the UHS period.

Refractory high-entropy superalloy (RHEA): An alloy formed of five or more elements, in substantially equal proportions, at least some of which are refractory metals.

C103 alloy: A solid-solution strengthened alloy formed of about 90% niobium, about 8% hafnium, and about 2% titanium.

Mullite: A material formed of alumina and silica. In some embodiments, the mullite can include other oxide materials, such as barium oxide and strontium oxide (e.g., barium strontium aluminum silicate (BSAS)).

Felt: A thin, flexible, porous structure. In some embodiments, the felt has a thickness of 1 mm or less. In some embodiments, the felt can be formed of carbon or graphite. In some embodiments, the felt has (i) a density of 0.1-0.5 g/cm³, inclusive, (ii) a porosity of 80-95%, inclusive, (iii) an electrical conductivity of 100-1000 S/m, inclusive, (iv) a thermal conductivity of 100-1000 W/m-K, inclusive, or any combination of (i)-(iv). In some embodiments, a carbon felt can be formed by carbonizing polyacrylonitrile (PAN) or rayon fibers.

Oxygen atmosphere: An atmosphere of pure oxygen gas or containing oxygen gas, for example, ambient air (e.g., having an oxygen concentration of ~21% by volume).

Inert atmosphere: An atmosphere of one or more gases that do not undergo a chemical reaction when subjected to the sintering temperature. In some embodiments, each gas in the inert atmosphere is selected from the group consisting of nitrogen, argon, helium, neon, krypton, xenon, radon, and oganesson.

### Introduction

Disclosed herein are methods for forming coatings on components via ultrafast high-temperature sintering (UHS). Because UHS is a non-equilibrium thermal process, a precursor layer (e.g., powder) on a component can be rapidly heated and densified, without the underlying component being exposed to the same temperature as the precursor layer. The transient nature of the UHS thus avoids subjecting the underlying component to temperatures that would otherwise cause the component to melt or severely degrade. In some embodiments, the coating, or a layer thereof, can be configured as a bond coat (e.g., an adhesive promoting layer, for example, a metallic or intermetallic layer). Alternatively or additionally, in some embodiments, the coating, or a layer thereof, can be configured as an environmental barrier coating (e.g., providing environmental protection (e.g., from oxidation and/or corrosion), for example, a metallic layer). Alternatively or additionally, in some embodiments, the coating, or a layer thereof, can be configured as environmental-thermal barrier (ETB) coating (e.g., providing both environmental protection and thermal insulation).

In some embodiments, the coating can be formed by subjecting one or more layers of precursors (e.g., powders) to UHS. In some embodiments, precursor layers can be sequentially deposited (e.g., via spray paint, slurry dip, and/or tape casting) on or over a surface of a component and then subjected to simultaneous UHS. Alternatively or additionally, precursor layers can be sequentially deposited on or over a surface of the component, and subjected to sequential UHS (e.g., after each layer deposition). In some embodiments, UHS-produced coatings can withstand thermal cycling, for example, by chemically adhering to the component surface.

In some embodiments, the methods disclosed herein can be used to test and identify novel coatings, for example, by offering facile execution, fast iteration efficiency (e.g., by simultaneous or sequential UHS of different layer compositions, different layer configurations, and/or different substrate compositions), temperature testing (e.g., by coating cycling and/or torch testing), relatively lower cost (e.g., for capital equipment), and good material compatibility (e.g., to produce two-phase materials, layers of different porosity, α-alumina, etc.). In some embodiments, selection of coatings, or components thereof, can be based on factors such as, but not limited to, thermal conductivity, long-term thermal stability, recession rate, substrate-coating compatibility, coefficient of thermal expansion (CTE) compatibility, spallation resistance, and/or calcium-magnesium-aluminosilicate (CMAS) resistance.

For example, in some embodiments, a coating, or component layers thereof, can be selected to have a CTE that substantially matches the CTE of the underlying substrate (e.g., a surface of the component in contact with the coating). Alternatively or additionally, in some embodiments, the coating, or component layers thereof, can be formed of mixed oxides or two-phase oxides (e.g., a two-phase material formed of an yttria-stabilized zirconia (YSZ) and α-alumina, or a two-phase material formed of zirconia and mullite), for example, to shift the CTE of the coating so as to substantially match the CTE of the underlying substrate. In some cases, thermal expansion mismatch between the coating and the substrate material can cause stresses to develop when the temperatures change (e.g., when cooling from a normal operating temperature or due to a sudden change in temperature). Such thermal expansion mismatch can be expressed as a strain and can be calculated as the integration over the temperature change of the difference between the CTE of the coating and the CTE of the substrate. The thermal expansion stresses are the product of the thermal expansion strains and the corresponding elastic moduli. By forming the coating with a CTE that substantially matches the CTE of the substrate, such thermal expansion stresses can be minimized, or at least reduced, thereby improving the protective performance and/or reliability of the coating.

Alternatively or additionally, in some embodiments, the coating, or component layers thereof, can be selected to have a customized porosity, for example, by controlling a temperature at which the UHS is performed. For example, UHS performed at lower sintering temperatures can yield sintered layers with higher porosity. In some embodiments, porosity in different layers of the coating can be tailored to achieve the best, or at least improved, thermal insulation and/or elastic modulus match, for example, by using staged UHS runs with different temperatures and/or durations. In some embodiments, the coating can have a dense top layer (e.g., outermost or exposed layer) and a porous intermediate layer (e.g., between the top layer and the substrate), for example, to elevate the thermal barrier efficiency of the coating and/or to reduce SiO₂ volatilization and glass formation. Alternatively, in some embodiments, the top layer of the coating can be porous, for example, a porous Gd₂Zr₂O₇ layer. Indeed, the UHS-based methods disclosed herein can afford unprecedented flexibility and efficiency in fabricating and developing high-quality coatings with not only different layer sequences, thicknesses, and/or porosity levels, but also novel layer compositions.

In some embodiments, UHS can offer rapid heating to the sintering temperature, which can avoid, or at least reduce, undesirable phase changes that are typically encountered with conventional coating techniques. For example, a coating with one or more layers of α-alumina can be formed from γ-alumina via UHS. With air plasma spray or electron-beam physical vapor deposition, coatings are produced that are in the metastable or amorphous alumina phases. During the phase transitions from the metastable phases to the stable α-alumina phase, large volume shrinkages occur that exceed the strength of the coating. These volume shrinkages can lead to cracking, which in turn exposes the underlying material (e.g., component surface) to oxidation. Alternatively or additionally, in some embodiments, the rapid heating and high temperatures enabled by UHS can allow formation of novel coating compositions that were otherwise not possible with conventional coating techniques. For example, CoAl₂O₄ can be produced by UHS of a mixture of constituent oxides such as CoO and Al₂O₃.

In some embodiments, multilayer coatings can be produced on complex (e.g., non-planar or contoured) surfaces of a component (e.g., a three-dimensional turbine blade shape) using UHS, for example, by using a flexible heating element (e.g., heating membrane or felt) that can conform to the component surface or by using a sacrificial heating member (e.g., a carbon film) conformally deposited over the component surface. In some embodiments, multilayer coatings can be produced from multilayer tape-casts followed by one or more UHS iterations to densify the tape-casts.

### Component Coatings

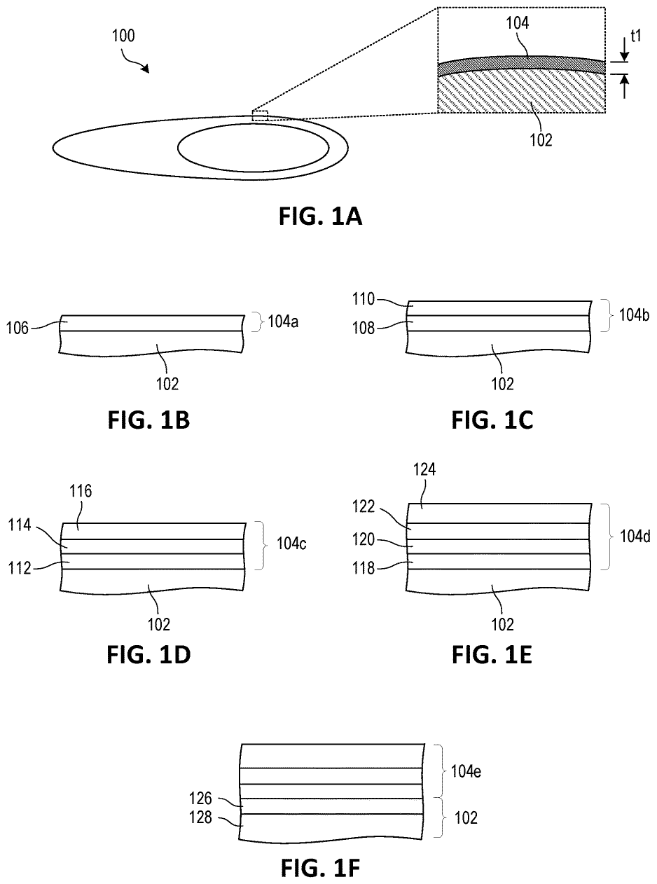

As noted above, in some embodiments, an environmental-thermal barrier (ETB) coating can be formed via UHS on a substantially nonplanar surface of a component. For example, FIG. 1A shows a UHS-formed ETB coating 104 formed on a curved surface portion 102 of a coated component 100. The ETB coating 104 can comprise a single layer or multiple layers (e.g., 2 or more distinct layers), and can have an overall thickness t1 (e.g., measured in a direction substantially perpendicular to the adjacent surface portion 102) less than or equal to 2 mm, for example, in a range of 100 μm to 2 mm, inclusive. In some embodiments, a bond coat (e.g., an adhesion promoting layer, such as but not limited to a nickel-chromium-aluminum alloy or platinum nickel aluminide alloy) can be provided between the ETB coating 104 and the surface portion 102 (e.g., when the bond coat is not formed by UHS) or as a component layer of the ETB coating in contact with surface portion 102 (e.g., when the bond coat is formed by UHS).

In some embodiments, an ETB coating material can have a CTE that substantially matches the CTE of the underlying substrate 102, and the ETB coating 104a formed by UHS can thus comprise a single layer 106 (e.g., a topcoat formed directly on the substrate surface), for example, as shown in FIG. 1B. In some embodiments, the substrate 102 can be formed of SiC, and the layer 106 can be formed of mullite, yttrium disilicate (YDS), hafnium silicate (Hf₄SiO₄), yttrium phosphate (YPO₄), or any combination thereof. Alternatively, in some embodiments, the substrate 102 can be formed of alumina (e.g., α-alumina), and the layer 106 can be formed of yttrium aluminum perovskite (YAP), yttrium aluminum garnet (YAG), barium zirconate (BaZrO₃), yttrium phosphate (YbPO₄), yttrium monosilicate (YMS), Er₄Hf₃O₁₂, ytterbium oxide (Yb₂O₃), mullite, gadolinium zirconate (Gd₂Zr₂O₇), or any combination thereof. Alternatively, in some embodiments, the substrate 102 can be a NbSi₂-coated C103 alloy substrate, and the layer 106 can be formed of alumina (e.g., α-alumina), mullite, BaZrO₃, Er₄Hf₃O₁₂, YMS, or any combination thereof.

Alternatively, in some embodiments, there may be relatively large CTE mismatch between the substrate and one or more of the ETB coating materials, and the ETB coating can thus comprise one or more additional layers, for example, with an intermediate CTE and/or elastic modulus. Alternatively or additionally, the additional layer(s) can have a different porosity, for example, to be more porous than a topmost layer of the ETB coating so as to further elevate thermal barrier efficiency and/or reduce SiO₂ volatilization and glass formation. Alternatively or additionally, the additional layer(s) can be used to adjust or improve other performance requirements, such as but not limited to minimizing, or at least reducing, volatilization in high velocity steam (e.g., by adding an outer layer that has a low intrinsic volatilization), improving adhesion to the underlying substrate (e.g., by adding a bond coat), and/or providing a gas barrier (e.g., by acting as a hermetic layer to minimize, or at least reduce, ingress of air at high temperatures). Alternatively or additionally, the additional layer(s) can be used to provide radiation reflective properties, for example, by providing an alternating sequence of layers with different refractive indices.

For example, in some embodiments, a bi-layer ETB coating 104b formed by UHS can comprise a bottom layer 108 and a top layer 110, as shown in FIG. 1C. The bottom layer 108 can be formed on and in direct contact with substrate 102, and the top layer 110 can be formed on and in direct contact with the bottom layer 108, with an upper surface of the top layer 110 being exposed. In some embodiments, the substrate 102 can be formed of SiC, the bottom layer 108 can be formed of mullite and/or Hf₄SiO₄, and the top layer 110 can be formed of YMS. Alternatively, in some embodiments, the substrate 102 can be formed of C103 alloy, the bottom layer 108 can be formed of niobium silicide (NbSi₂), and the top layer 110 can be formed of alumina (e.g., α-alumina), mullite, BaZrO₃, Er₄Hf₃O₁₂, YMS, or any combination thereof. Alternatively, in some embodiments, the substrate 102 can be formed of alumina (e.g., α-alumina), the bottom layer 108 can be formed of mullite, and the top layer 110 can be formed of YMS.

For example, in some embodiments, a tri-layer ETB coating 104c formed by UHS can comprise a bottom layer 112, an intermediate layer 114, and a top layer 116, and, as shown in FIG. 1D. The bottom layer 112 can be formed on and in direct contact with substrate 102, and the intermediate layer 114 can be formed on and in direct contact with the bottom layer 112. The top layer 116 can be formed on and in direct contact with the intermediate layer 114, with an upper surface of the top layer 116 being exposed. In some embodiments, the substrate 102 can be formed of SiC, the bottom layer 112 can be formed of mullite and/or Hf₄SiO₄, the intermediate layer 114 can be formed of mullite and/or YDS, and the top layer can be formed of YMS. For example, an ETB coating formed on a SiC substrate can have a multilayer stack of YMS, mullite, and Hf₄SiO₄ in order from top to bottom. In another example, an ETB coating formed on a SiC substrate can have a multilayer stack of YMS, YDS, and mullite in order from top to bottom.

In some embodiments, the substrate 102 can be formed of C103 alloy, the bottom layer 112 can be formed of NbSi₂, the intermediate layer 114 can be formed of BaZrO₃, alumina (e.g., α-alumina), mullite, Er₄Hf₃O₁₂, or combinations thereof, and the top layer can be formed of YMS. For example, an ETB coating formed on a C103 alloy substrate can have a multilayer stack of YMS, BaZrO₃, and NbSi₂ in order from top to bottom. In another example, an ETB coating formed on a C103 alloy can have a multilayer stack of YMS, alumina, and NbSi₂ in order from top to bottom. In still another example, an ETB coating formed on a C103 alloy substrate can have a multilayer stack of YMS, mullite, and NbSi₂ in order from top to bottom. In yet another example, an ETB coating formed on a C103 alloy substrate can have a multilayer stack of YMS, Er₄Hf₃O₁₂, and NbSi₂ in order from top to bottom.

For example, in some embodiments, a four-layer ETB coating 104d formed by UHS can comprise a bottom layer 118, a lower intermediate layer 120, an upper intermediate layer 122, and a top layer 124, as shown in FIG. 1E. The bottom layer 118 can be formed on and in direct contact with substrate 102, and the lower intermediate layer 120 can be formed on and in direct contact with the bottom layer 118. The upper intermediate layer 122 can be formed on and in direct contact with the lower intermediate layer 120, and the top layer 124 can be formed on and in direct contact with the upper intermediate layer 122, with an upper surface of the top layer 124 being exposed. In some embodiments, the substrate 102 can be formed of SiC, the bottom layer 118 can be formed of mullite, the lower intermediate layer 120 can be formed of YDS, the upper intermediate layer 122 can be formed of YMS, and the top layer 124 can be formed of gadolinium zirconate (Gd₂Zr₂O₇), yttria (Y₂O₃), ytterbium oxide (Yb₂O₃), or any combination thereof. For example, an ETB coating formed on a SiC substrate can have a multilayer stack of porous Gd₂Zr₂O₇, YMS, YDS, and mullite in order from top to bottom. In another example, an ETB coating formed on a SiC substrate can have a multilayer stack of Y₂O₃, YMS, YDS, and mullite in order from top to bottom. In still another example, an ETB coating formed on a SiC substrate can have a multilayer stack of Yb₂O₃, YMS, YDS, and mullite in order from top to bottom.

In some embodiments, the substrate 102 can be formed of C103 alloy, the bottom layer 118 can be formed of NbSi₂, the lower intermediate layer 120 can be formed of mullite, the upper intermediate layer 122 can be formed of YMS, and the top layer 124 can be formed of gadolinium zirconate (Gd₂Zr₂O₇), yttria (Y₂O₃), ytterbium oxide (Yb₂O₃), or any combination thereof. For example, an ETB coating formed on a C103 alloy substrate can have a multilayer stack of porous Gd₂Zr₂O₇, YMS, mullite, and NbSi₂ in order from top to bottom. In another example, an ETB coating formed on a C103 alloy substrate can have a multilayer stack of Y₂O₃, YMS, mullite, and NbSi₂ in order from top to bottom. In still another example, an ETB coating formed on a C103 alloy substrate can have a multilayer stack of Yb₂O₃, YMS, mullite, and NbSi₂ in order from top to bottom.

While FIGS. 1A-1E illustrate the ETB coating in direct contact with the substrate (e.g., via a bottom-most layer of the coating), one or more intervening layers (e.g., bond coat) can be provide between the ETB coating and the substrate according to one or more contemplated embodiments. In some embodiments, the intervening layers can be formed on the substrate by a method other than UHS. Alternatively or additionally, the intervening layer(s) can be considered as part of the substrate (e.g., as a surface layer). For example, FIG. 1F illustrates a substrate 102 having a base material 128 with a surface layer 126 formed thereon, while a trilayer ETB 104e is formed on and in direct contact with (the surface layer 126 e.g., via the bottom-most layer of the coating 104e). In some embodiments, the base material 128 can be formed of a C103 alloy, and the intervening layer 126 can be formed of NbSi₂.

Although coatings with one to four layers is illustrated in FIGS. 1B-1F, embodiments of the disclosed subject matter are not limited thereto. Rather, any number of layers is possible for the coating according to one or more contemplated embodiments. In addition, although FIG. 1F shows the substrate 102 including a single surface layer 126, any number of layers for the substrate (or between the substrate and the UHS-formed coating (whether single layer or multilayer)) is also possible according to one or more contemplated embodiments.

In some embodiments, the coating formed by UHS can be other than an ETB coating. For example, the single layer 106 of FIG. 1B can be configured as a bond coat (e.g., a metallic or intermetallic layer), without any other layers (e.g., ceramic (oxide) coatings) formed thereover. In another example, the single layer 106 of FIG. 1B can be an environmental barrier coating (e.g., a metallic layer), without any other layers (e.g., ceramic (oxide) coatings) formed thereover. Other configurations and variations for the coating formed by UHS are also possible according to one or more contemplated embodiments.

### Ultrafast High Temperature Sintering (UHS) Configurations

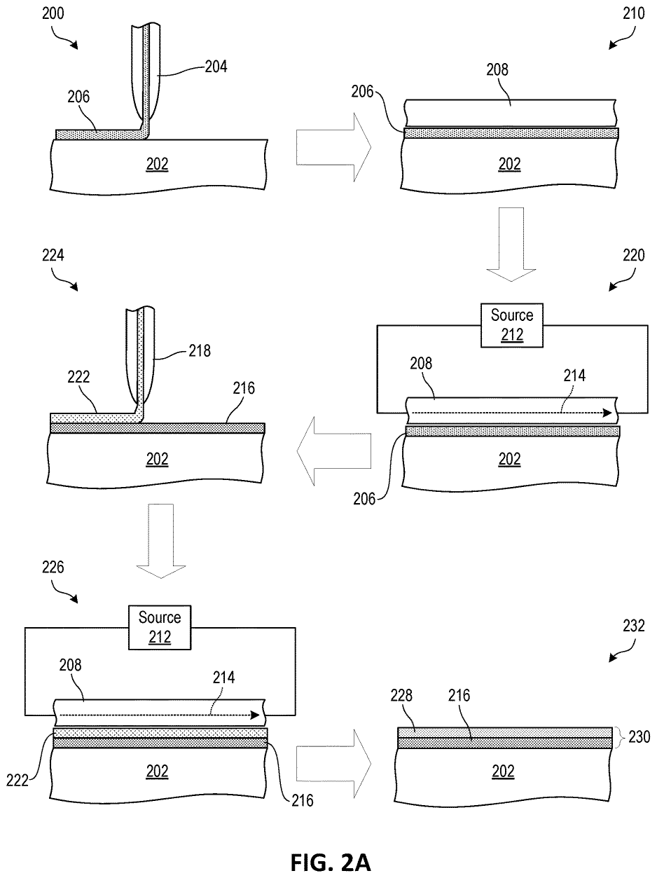

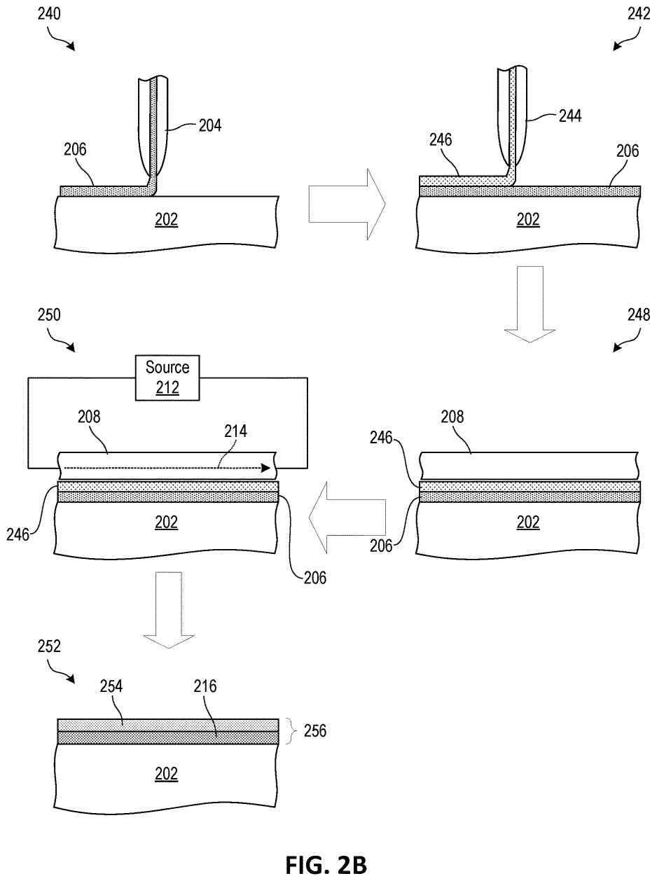

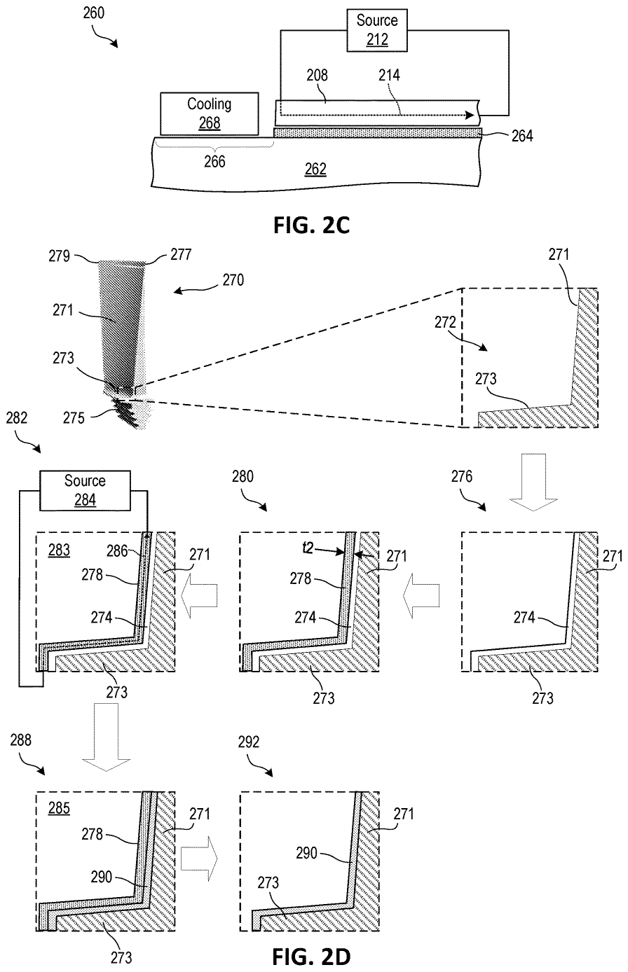

Referring to FIG. 2A, an exemplary UHS process for forming one or more layers of a coating 230 on a component 202 is shown. During a first deposition stage 200, one or more first precursors (e.g., powders) can be provided on an exposed surface of the component 202. In the illustrated example of FIG. 2A, a printhead 204 is used to deposit a first precursor layer 206; however, any method of deposition can be used to provide the first precursor layer 206, such as but not limited to spray coating, dip coating, printing, tape casting, and slip casting.

At a first heater positioning stage 210, one or more Joule heating elements 208 can be positioned with respect to the first precursor layer 206. In some embodiments, the Joule heating element(s) 208 can be flexible (e.g., as a thin membrane, for example, having a thickness ≤1 mm) and can be positioned such that the Joule heating element conforms to a shape of the surface of the component 202. For example, in some embodiments, the heating element can be positioned with each portion thereof in contact with a corresponding facing portion of the precursor layer. Alternatively, in some embodiments, the heating element can be positioned with only some portions thereof in contact with the precursor layer. Alternatively or additionally, in some embodiments, the heating element may initially be positioned in contact with the precursor layer (e.g., at one or a few points), but then is moved out of contact without the precursor layer prior to and/or during UHS, for example, to avoid undesirable interactions between the heating element and the precursors during UHS (e.g., carbide formation) and/or melting of the component 202. Alternatively or additionally, in some embodiments, the heating element can be spaced from the component 202 in the first heater positioning stage, for example, at least adjacent to the first precursor layer 206 (e.g., ≤1 cm spacing). In some embodiments, the Joule heating element spaced from the component follows a shape of the component surface, for example, with each portion of the heating element being substantially equidistant from the corresponding facing portion of the precursor layer and/or the underlying component surface.

In some embodiments, the Joule heating element(s) 208 can be formed of conductive carbon (e.g., carbon felt or membrane, a graphite felt or membrane, a carbon film, a graphite film, a carbon nanotube film). Alternatively or additionally, in some embodiments, the Joule heating element(s) 208 can be formed of other conductive materials, such as but not limited to metal and carbide. In some embodiments, the heater positioning stage 210 can include moving the Joule heating element(s) 208 from a prior position on or over the component 202, for example, to provide sequential sintering over the surface of the component 202 (e.g., by gradually or periodically moving the Joule heating element while energized).

At a first UHS stage 220, an electric power source 212 can direct an electric current 214 through the Joule heating element(s) 208 so as to cause Joule heating thereof. In some embodiments, the direction of the current flow through the heating element(s) can be substantially parallel to a surface of the component 202 and/or the precursor layer 206, for example, from an electrical connection at one end of the heating element 208 to an electrical connection at an opposite end of the heating element 208. The Joule heating of the heating element(s) 208 can expose the precursor layer 206 to a sintering temperature for a limited time (e.g., 10 seconds to 2 minutes), which is effective to convert the first precursor layer 206 (e.g., powder) into a first sintered layer 216 (e.g., a continuous porous or dense layer) without thermal degradation of the underlying component.

After the first UHS stage 220, additional layers can optionally be formed atop the first sintered layer 216, for example, to provide a multilayer coating (e.g., an ETB coating). For example, at second deposition stage 224, one or more second precursors (e.g., powders) can be provided over an exposed surface of the first sintered layer 216. In the illustrated example of FIG. 2A, another printhead 218 is used to deposit the second precursor layer 222; however, the same printhead 204 as the first deposition stage 200 can be used in some embodiments. Moreover, any method of deposition can be used to provide the second precursor layer 222, such as but not limited to spray coating, dip coating, printing, tape casting, and slip casting.

One or more Joule heating elements 208 can then be positioned with respect to the second precursor layer 222 and energized via electric current 214 in a manner similar to that described above for the first heater positioning stage 210 and the first UHS stage 220, respectively. The Joule heating of the heating element(s) 208 can expose the precursor layer 222 to a sintering temperature for a limited time, which is effective to convert the second precursor layer 222 (e.g., powder) into a second sintered layer 228 (e.g., a continuous porous or dense layer) without thermal degradation of the underlying component, thereby forming a coated component 232. In some embodiments, the sintering temperature and/or UHS duration of the second UHS stage 226 can be different than that of the first UHS stage 220. In the illustrated example of FIG. 2A, the same Joule heating element(s) and power source 212 are used for the first UHS stage 220 and second UHS stage 226; however, different Joule heating elements and/or power sources can be used for each stage. In some embodiments, stages 224-226 can be repeated to add additional layers for the coating over the first and second sintered layers.

In the illustrated example of FIG. 2A, the first and second sintered layers are formed by sequential application of UHS. Alternatively or additionally, in some embodiments, multiple layers can be simultaneously formed on the component via a single UHS application, for example, as shown in FIG. 2B. During a first deposition stage 240, a first precursor layer 206 can be provided on an exposed surface of the component 202, for example, in a manner similar to that described above for first deposition stage 200 of FIG. 2A. After the first deposition stage 240 and before UHS, one or more additional layers can be formed atop the first precursor layer 206, for example, to provide a multilayer coating (e.g., ETB coating). For example, at second deposition stage 242, one or more second precursors (e.g., powders) can be provided over an exposed surface of the first precursor layer 206. In the illustrated example of FIG. 2B, another printhead 244 is used to deposit the second precursor layer 246; however, the same printhead 204 as the first deposition stage 240 can be used in some embodiments. Moreover, any method of deposition can be used to provide the second precursor layer 246, such as but not limited to spray coating, dip coating, printing, tape casting, and slip casting.

At a heater positioning stage 248, one or more Joule heating elements 208 can be positioned in contact with or at least adjacent to (e.g., ≤1 cm spacing) the topmost layer, e.g., second precursor layer 246, for example, in a manner similar to that described above for first heater positioning stage 210 of FIG. 2A. At UHS stage 250, an electric power source 212 can direct an electric current 214 through the Joule heating element(s) 208 so as to cause Joule heating thereof and thereby simultaneously sinter layers 206, 246 without thermal degradation of the underlying component, for example, in a manner similar to that described above for first UHS stage 220 or second UHS stage 226 in FIG. 2A. The resulting coated component 252 can thus have a multi-layer coating 256 (e.g., ETB coating) formed by first sintered layer 216 and second sintered layer 254. In some embodiments, stages 240, 242, 248, and/or 250 can be repeated to add additional layers for the coating over the first and second sintered layers.

In some embodiments, the Joule heating element may have a size (e.g., surface area) smaller than that of the to-be-coated surface of the component, for example, such that a least part of the component extends beyond a heating zone and/or is exposed from the heating element. In some embodiments, the area of the component outside the heating zone can be cooled during applications of UHS, for example, to minimize or at least reduce thermal degradation of the underlying component during UHS. For example, FIG. 2C illustrates an exemplary configuration 260 for processing of a precursor layer 264 on a component 262 (e.g., a long and/or thick SiC substrate) via UHS (e.g., via current flow 214 from source 212 through Joule heating element 208). At least a portion 266 of component 262 can be exposed from the heating element 208 during the sintering, and the portion 266 can be in thermal communication (e.g., for conductive, convective, and/or radiative heat transfer) with cooling mechanism 268 (e.g., via active and/or passive cooling mechanisms). Other configurations for cooling of a to-be-coated component during UHS application are also possible according to one or more contemplated embodiments.

Although the flexible Joule heating element (e.g., flexible membrane, such as carbon felt) can be bent to conform to various surfaces, some components may have complex surface geometries that make it difficult to match using a separate heating element. In some embodiments, the heating element can instead be a layer deposited over the component (e.g., on an outermost precursor layer) that can be energized to provide UHS (e.g., by passing a current therethrough) and then removed once the underlying precursor has been sintered (e.g., by heating in an oxygen atmosphere).

For example, FIG. 2D shows an exemplary UHS process for forming a layer of a coating (e.g., ETB coating) on a component 270 using an in situ heating element. In the illustrated example, the component 270 is configured as a turbine blade, although the disclosed method can be applied to other types of components as well. The turbine blade comprises an airfoil 271 having a leading edge 277 and a trailing edge 279. The airfoil 271 is disposed on one side of and extends from platform 273, while dovetails 275 on an opposite side of the platform 273 are used to secure the blade to a turbine disk. In some embodiments, surfaces of the airfoil 271 and platform 273 can be provided with an ETB coating, and the curvature of the airfoil 271 and/or the intersection between platform 273 and airfoil 271 can present a complex surface 272 to which it may be difficult for a heating element to conform.

At precursor deposition stage 276, one or more first precursors can be deposited (e.g., via spray coating, dip coating, printing, tape casting, slip casting, etc.) on the surfaces of the platform 273 and airfoil 271 to form a first precursor layer 274. After the first precursor layer 274 is formed, at heating film deposition stage 280, a Joule heating film 278 can be formed (e.g., via spray coating, dip coating, printing, tape casting, slip casting, etc.) on or over the first precursor layer 274. In some embodiments, the Joule heating film 278 can be formed of conductive carbon, such as carbon black, carbon nanotubes, graphite, or any combination thereof. For example, the Joule heating film 278 can have a thickness (t2) less than or equal to 1 mm and/or a resistivity in a range of 0.02-1 Ω·m, inclusive.

At UHS stage 282, an electric power source 284 can direct an electric current 286 through the Joule heating film 278 so as to cause Joule heating thereof. The Joule heating during UHS process (e.g., at least UHS stage 282, as well as any UHS stages 220, 226, 250 discussed above) can be performed in an inert atmosphere 283 or in a vacuum. In some embodiments, the direction of the current flow through the heating film can be substantially parallel to a surface of the component 271 and/or the precursor layer 274, for example, from an electrical connection at one end of the heating film 278 to an electrical connection at an opposite end of the heating film 278. The Joule heating of the heating film 278 can expose the precursor layer 274 to a sintering temperature for a limited time (e.g., 10 seconds to 2 minutes), which is effective to convert the first precursor layer 274 (e.g., powder) into a sintered layer 290 (e.g., a continuous porous or dense layer) without thermal degradation of the underlying component.

After the UHS stage 282, the heating film 278 can be removed in removal stage 288, thereby exposing the layer 290 in the coated component 292. In some embodiments, the heating film 278 can be heated (e.g., at a temperature of 1000° C. or less, such as 400-500° C.) in an oxygen atmosphere 285 such that the heating film 278 is burnt off, for example, by converting the carbon of the film 278 to vapor (e.g., gaseous carbon dioxide). Other mechanisms for removing the deposited heating film 278 are also possible according to one or more contemplated embodiments.

### Fabrication Methods

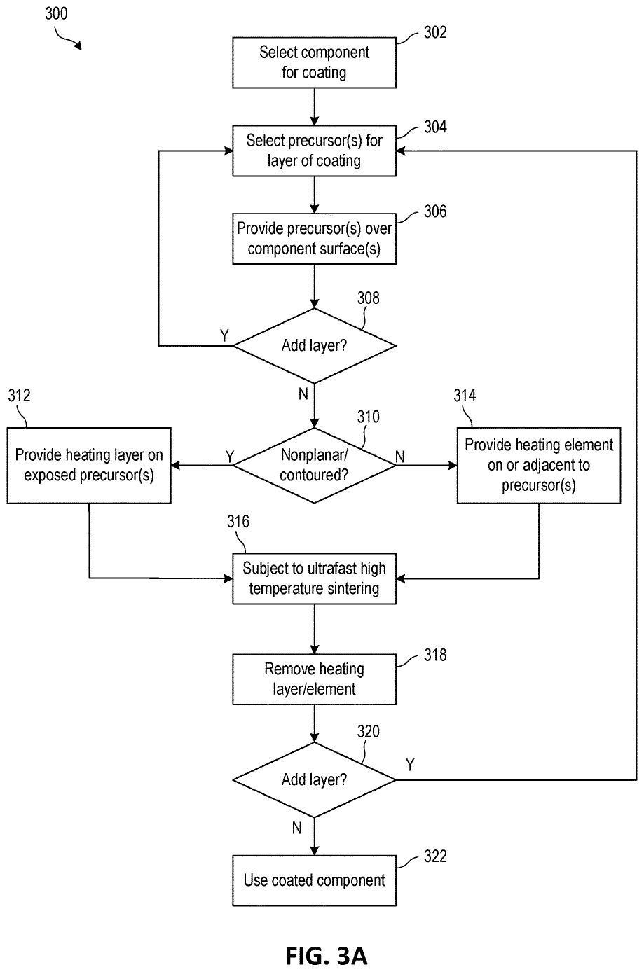

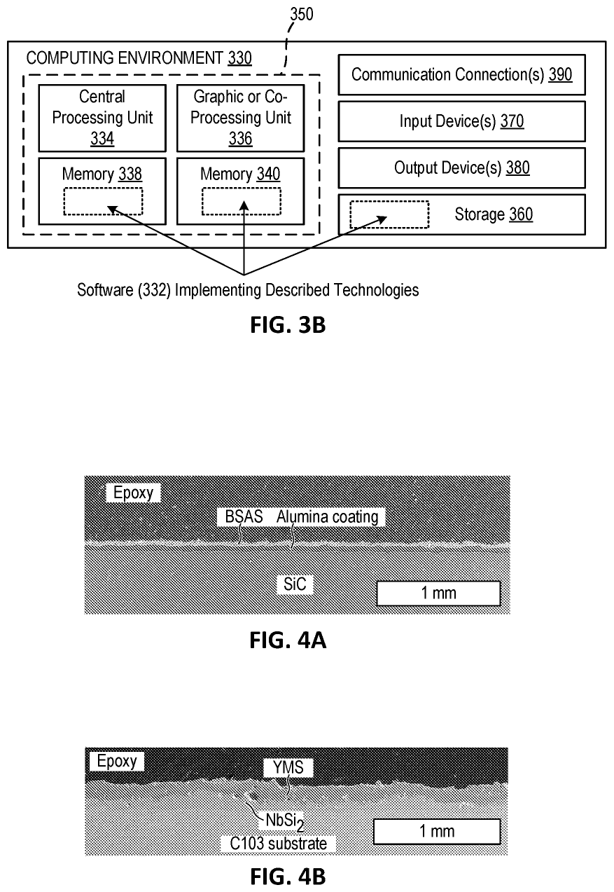

FIG. 3A illustrates a method 300 for fabrication and use of a coated component. The method 300 can initiate at process block 302, where a component to be coated can be selected. In some embodiments, the component selection can include selecting a material of the component (e.g., coating substrate). In some embodiments, the material for the component can be a metal, metal alloy, metal oxide, and/or ceramic matrix composite. For example, the component can be formed of a refractory high-entropy superalloy. In some embodiments, the component comprise silicon carbide (SiC), niobium (Nb), hafnium (Hf), titanium (Ti), molybdenum (Mo), silicon (Si), boron (B), alumina (Al₂O₃), or any combination or alloy thereof. For example, the component can be formed of an alloy or cermet comprising SiC, Mo—Si—B alloy, Nb-silicide, C103 alloy, alumina, or a nickel-based superalloy. In some embodiments, the component can be a part of a gas turbine, such as a turbine blade or combustor. However, embodiments of the disclosed subject matter are not limited to coating of gas-turbine engine components. Rather, in some embodiments, the selected component can be for any environment where high temperature and environmental resistance is desirable, such as, but not limited to, jet engines, rocket engines, nuclear reactors, etc.

The method 300 can proceed to process block 304, where one or more precursors (e.g., first precursor(s), such as a powder) can be selected. In some embodiments, the selection of precursor(s) can be based on thermal conductivity, thermal stability, recession rate, substrate-coating compatibility, CTE compatibility, spallation resistance, CMAS corrosion resistance, material cost, material availability, and/or any other desired selection criteria. In some embodiments, precursor(s) selected in process block 304 can include multiple materials to be incorporated into a single layer, for example, to form a two-phase layer.

The method 300 can proceed to process block 306, where the selected precursor(s) can be provided on or cover a surface of the component. In some embodiments, provision of process block 306 can include spray coating, dip coating, printing, tape casting, slip casting, and/or any other deposition methodology. In some embodiments, the provision of process block 306 can include one or more pre-sintering steps, such as but not limited to drying of a deposited slurry and/or pretreatment (e.g., calcination).

The method 300 can proceed to decision block 308, where it is determined if an additional precursor layer (e.g., second precursor(s)) should be provided and sintered at a same time (e.g., co-sintered). If co-sintering of layers is desired (e.g., when sintering of the first and second precursors is possible at a same sintering temperature and duration), the method 300 can return to process block 304 for selection of the precursor(s) and subsequent provision of the selected precursor(s) at process block 306.

If co-sintering of layers is not desired or if all desired additional layers have been provided at decision block 308, the method 300 can proceed to decision block 310, where it is determined if the component surface has a complex nonplanar or contoured shape. In some embodiments, if the component surface has a complex nonplanar or contoured shape, an in situ heating film can be used to provide UHS. In such cases, the method 300 can proceed from decision block 310 to process block 312, where a heating film can be formed on the exposed precursor(s) (e.g., a top-most precursor layer). In some embodiments, the heating film can be a conductive carbon film (e.g., formed of carbon nanotubes or carbon black) formed over the component surface by spray coating, dip coating, printing, tape casting, slip casting, or any other deposition method. In some embodiments, the provision of process block 312 can include processing of the heating film (e.g., to dry a deposited film) and/or making electrical connection to the heating film (e.g., by attaching electrical connections at opposite ends of the film).

If the component surface does not have a complex nonplanar or contoured shape or can otherwise be accommodated by the flexibility of a separate heating element at decision block 310, the method 300 can proceed to process block 314, where a separate Joule heating element (e.g., a conductive felt, membrane, or film formed of metal, carbide, or carbon) can be provided in contact with or adjacent to (e.g., at a constant spacing from) the exposed precursor(s) (e.g., a top-most precursor layer). In some embodiments, the provision of process block 314 can include shaping the heating element to conform to the shape of the component surface.

The method 300 can proceed to process block 316, where the heating element can be used to subject the precursor(s) to UHS. For example, an electric current can be passed through the heating element (e.g., the in situ heating film deposited on the precursor(s) or the separate heating element provided on or adjacent to the precursor(s)) so as to cause Joule heating thereof. In some embodiments, the Joule heating can be effective to generate a sintering temperature in a range of 500-3273 K, for example, at least 2000 K, and the sintering temperature of the UHS can be maintained for a duration of no more than 10 minutes (e.g., in a range of 10 second to 2 minutes). In some embodiments, the subjecting of process block 316 can include heating to the sintering temperature and/or cooling from the sintering temperature, for example, at a ramp rate of at least 10² K/s (e.g., in a range of 10³-10⁵ K/s). In some embodiments, the UHS can be performed in an inert environment or under vacuum. Alternatively, in some embodiments, the UHS can be performed in different environments and/or at different temperatures.

The method 300 can proceed to process block 318, where the heating element can be removed. In some embodiments, when the heating element is an in situ heating film, the removal of process block 318 can include burning off the heating film, for example, by exposing to a temperature of 400-500° C. in an oxygen atmosphere so as to convert the carbon in the film into vapor (e.g., gaseous carbon dioxide). Alternatively, when the heating element is a separate heating element, the removal of process block 318 can include moving the heating element away from the component surface for disposal and/or reuse (e.g., to perform UHS another section of the component or to perform UHS another component).

The method 300 can proceed to decision block 320, where it is determined if an additional precursor layer (e.g., second precursor(s)) should be provided and sequentially sintered. If sequential sintering of layers is desired (e.g., when sintering of the first and second precursors is at different sintering temperatures and/or durations), the method 300 can return to process block 304 for selection of the precursor(s) and subsequent precursor provision 306, heating element provision 312 or 314, UHS 316, and heating element removal 318.

If sequential sintering of additional layers is not desired or if all desired additional layers have been provided at decision block 320, the method 300 can proceed to process block 322, where the coated component can be used or processed for use. In some embodiments, the coated component can be used alone or with other coated or uncoated components in a high-temperature application (e.g., at least 1300° C., such as about 1700° C.), for example, in a gas-turbine. Alternatively or additionally, in some embodiments, the use of process block 322 can include testing (e.g., thermal cycling and/or torch testing), for example, to determine suitability of the coating for a particular application.

Although blocks 302-322 of method 300 have been described as being performed once, in some embodiments, multiple repetitions of a particular process block may be employed before proceeding to the next decision block or process block. In addition, although blocks 302-322 of method 300 have been separately illustrated and described, in some embodiments, process blocks may be combined and performed together (simultaneously or sequentially). Moreover, although FIG. 3A illustrates a particular order for blocks 302-322, embodiments of the disclosed subject matter are not limited thereto. Indeed, in certain embodiments, the blocks may occur in a different order than illustrated or simultaneously with other blocks. In some embodiments, method 300 may comprise only some of blocks 302-322 of FIG. 3A.

### Computer Implementation

FIG. 3B depicts a generalized example of a suitable computing environment 330 in which the described innovations may be implemented, such as but not limited to aspects of electric power source 212, cooling mechanism 268, a controller of a UHS and/or coating process, and/or method 300. The computing environment 330 is not intended to suggest any limitation as to scope of use or functionality, as the innovations may be implemented in diverse general-purpose or special-purpose computing systems. For example, the computing environment 330 can be any of a variety of computing devices (e.g., desktop computer, laptop computer, server computer, tablet computer, etc.).

With reference to FIG. 3B, the computing environment 330 includes one or more processing units 334, 336 and memory 338, 340. In FIG. 3B, this basic configuration 350 is included within a dashed line. The processing units 334, 336 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 3B shows a central processing unit 334 as well as a graphics processing unit or co-processing unit 336. The tangible memory 338, 340 may be volatile memory (e.g., registers, cache, RAM), non-volatile memory (e.g., ROM, EEPROM, flash memory, etc.), or some combination of the two, accessible by the processing unit(s). The memory 338, 340 stores software 332 implementing one or more innovations described herein, in the form of computer-executable instructions suitable for execution by the processing unit(s).

A computing system may have additional features. For example, the computing environment 330 includes storage 360, one or more input devices 370, one or more output devices 380, and one or more communication connections 390. An interconnection mechanism (not shown) such as a bus, controller, or network interconnects the components of the computing environment 330. Typically, operating system software (not shown) provides an operating environment for other software executing in the computing environment 330, and coordinates activities of the components of the computing environment 330.

The tangible storage 360 may be removable or non-removable, and includes magnetic disks, magnetic tapes or cassettes, CD-ROMs, DVDs, or any other medium which can be used to store information in a non-transitory way, and which can be accessed within the computing environment 330. The storage 360 can store instructions for the software 332 implementing one or more innovations described herein.

The input device(s) 370 may be a touch input device such as a keyboard, mouse, pen, or trackball, a voice input device, a scanning device, or another device that provides input to the computing environment 330. The output device(s) 380 may be a display, printer, speaker, CD-writer, or another device that provides output from computing environment 330.

The communication connection(s) 390 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

A database of coefficients of thermal expansion (CTE) at various temperatures for different substrate materials and coating candidates was developed. The potential coating materials were analyzed with respect to representative substrates with different CTEs (e.g., SiC, C103 alloy, and α-alumina). Based on the CTE calculations, multiple potential coating compositions with relatively acceptable CTE compatibility were identified for each substrate. High-throughput ultrafast high temperature sintering (UHS) followed by trial-and-error experiments (e.g., coating cycling and torch tests) were conducted to select coating-substrate compositions with better thermomechanical stabilities.

To form the coatings on the substrate for testing, sequential spray paints of different particle inks were used, which allowed high-throughput and cost-effective formation of multi-layer coatings with different compositions, layer stacking sequences, and layer thicknesses. UHS enables the multi-layer ETB coatings to be sintered in one run in less than a minute with multiple samples in each run to achieve high throughput. A carbon felt strip was employed as the heating element and placed atop the coating to be sintered. A DC power source (with tunable current and voltage) was used to elevate the temperature of the heating element via self-induced Joule heating. The temperature of the heating element was measured from the UV-Vis spectra captured with a high-speed camera. Sintering temperature depended on the material of the precursors (e.g., powders) for the coating, but was generally in a range of 1500-3000° C. Duration of the applied sintering temperature was generally in a range of 10 seconds to 2 minutes.

ETB coatings with different compositions, thicknesses, and layer sequences were fabricated on surrogate alloy substrates, such as Nb silicide alloys, polycrystalline SiC, and refractory high-entropy superalloys. The coated substrates were then tested for thermal conductivity, thermal stability, and resistance to thermal cycling and calcium-magnesium-aluminosilicate (CMAS).

FIG. 4A shows an example of a bilayer coating formed on a SiC substrate via UHS. The bilayer coating in FIG. 4A comprises a top layer formed of barium strontium aluminum silicate (BSAS) and a bottom layer of alumina. FIG. 4B shows another example of a bilayer coating formed on a C103 alloy substrate via UHS. The bilayer coating in FIG. 4B comprises a top layer formed of yttrium monosilicate (YMS) and a bottom layer of niobium disilicide (NbSi₂) layer. The bilayer coatings of FIGS. 4A-4B exhibit good uniformity, and each topcoat exhibits good density (e.g., substantially non-porous) so as to minimize otherwise volatile SiO₂ in the coatings. An energy-dispersive X-ray spectroscopy (EDS) line scan of the bilayer coating of FIG. 4B showed a clear, chemically-distinct boundary between the layers of the coating, thus indicating that, even at the very high temperatures (e.g., ≥1500° C.) reached during the UHS process, there is minimal reaction between the layers and good interface stability.

The UHS process was used to customize coatings with respect to the CTEs of the underlying substrate material. In some cases, two-phase materials with tailored CTEs can be created for the coating. For example, two-phase oxide coatings (e.g., yttria-stabilized zirconia (YSZ) and α-alumina) were formed via UHS at different sintering temperatures (e.g., 1800° C. for 10 seconds and 2500° C. for 10 seconds). FIG. 7A shows the coating formed via UHS at 1800° C., while FIGS. 7B-7C show the coating formed via UHS at 2500° C., with the bright phase corresponding to YSZ. As shown in the EDS mapping of FIG. 7C, the coating retains the two-phase structure, even with the higher sintering temperature. The coatings also exhibit good adhesion to the underlying substrate.

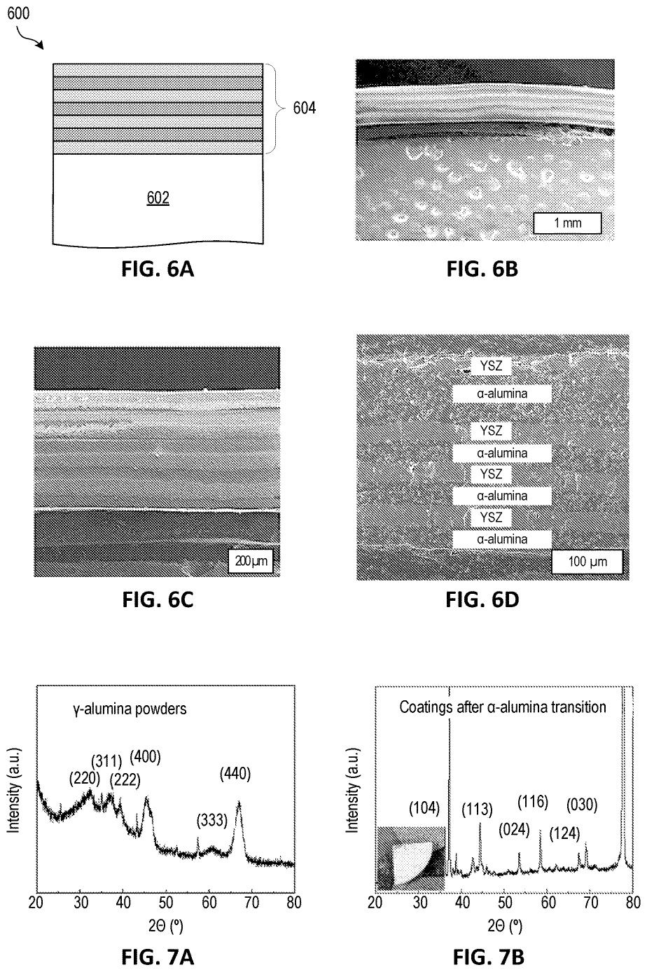

Alternatively or additionally, a coating 604 comprising multiple layers (e.g., in a periodic stack) can be used to customize the coating with respect to the CTE of the underlying substrate material 602, for example, as shown for the coated component 600 of FIG. 6A. For example, UHS was used to produce a coating of alternating layers of YSZ and α-alumina (e.g., seven layers total). FIGS. 6B-6C show the initial layers of YSZ and alumina (e.g., precursor tape layers) provided on a substrate via a tape casting prior to sintering, and FIG. 6D shows the resulting structure with multilayer coating after UHS.

In some cases, UHS can be used to produce coatings that are not currently possible with conventional fabrication techniques. For example, a coating of α-alumina, which is the most stable phase of alumina, cannot be formed using conventional thermal spray techniques. In contrast, UHS was used to convert a precursor powder of γ-alumina on a substrate (as shown by the X-ray diffraction (XRD) analysis of FIG. 7A) to an α-alumina coating (as shown by the XRD analysis of FIG. 7B) without phase-transformation-induced cracking from the sintering.

A thermal cycling test system was used to test the stability of UHS-fabricated coatings at 1300° C., in particular, a single layer coating of α-alumina on SiC substrates. A camera was used to image the coatings during/after cycling to detect spalling. An automated program was used to control movement of the coated samples into and out of a furnace at specified time intervals (e.g., each cycle including 30 minutes within the furnace at 1300° C. and 25 minutes out of the furnace at room temperature). After 500 cycles at 1300° C., the α-alumina coating remained adhered to the underlying SiC substrate.

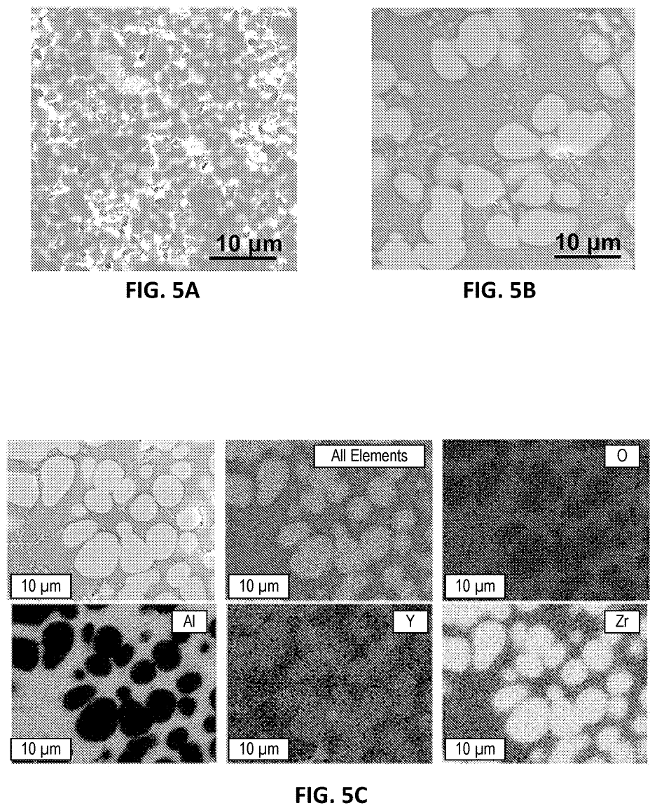

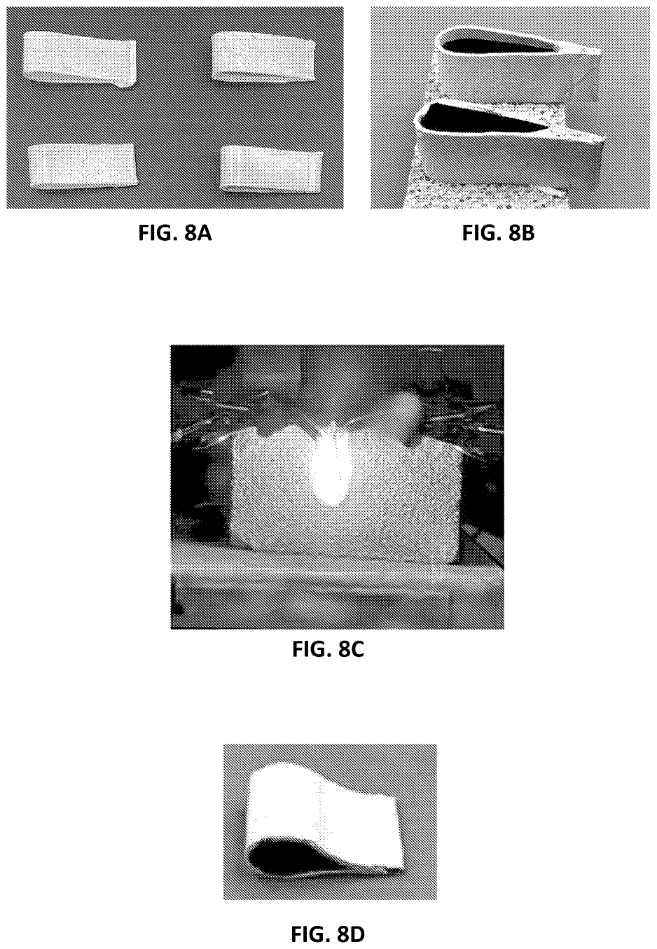

Although the examples of FIGS. 4A-7B involve components with substantially planar surfaces to be coated, employing a flexible heating element (e.g., flexible carbon felt) can allow the UHS to be applied to sinter coatings for components with irregular shapes (e.g., nonplanar or contoured surfaces). The flexible heating element can be bent, shaped, or otherwise positioned to follow (e.g., conform) to the surface to be coated (e.g., in contact with the precursors disposed on the component surface or at a substantially constant spacing from the precursors). To demonstrate this approach, airfoil-shaped components derived from a part of a niobium tube were used as sample substrates. YMS was tape cast over the external surfaces of the substrates, as shown in FIG. 8A. The YMS tape coated substrates were then subjected to calcination (e.g., 200° C. for 0.5 hours, followed by 400° C. for 1.5 hours), after which the coating remained attached to the substrate, as shown in FIG. 8B. UHS was then performed by using a curved carbon felt heater to conformally heat the YMS tape coated substrate, as shown in FIG. 8C. After UHS, the YMS coatings were deposited on and chemically adhered to the substrate, as shown in FIG. 8D.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A method comprising:
(a) providing one or more first precursors over a surface of a component to be coated;
(b) providing a heating element over the one or more first precursors; and
(c) sintering the one or more first precursors to form a first layer over the component surface by subjecting the one or more first precursors to a sintering temperature in a range of 500-3273 K, inclusive, for a duration of less than or equal to 10 minutes,
wherein the sintering temperature is generated by passing an electric current through the heating element to cause Joule heating of the heating element.

Clause 2. The method of any clause or example herein, in particular, Clause 1, wherein the providing of (b) is such that the heating element substantially conforms to a shape of the component surface.

Clause 3. The method of any clause or example herein, in particular, any one of Clauses 1-2, wherein the first layer formed by (c) comprises or is a layer of an environmental-thermal barrier (ETB) coating, an environmental barrier coating, or a bond coat.

Clause 4. The method of any clause or example herein, in particular, any one of Clauses 1-3, wherein the providing of (a) comprises spray coating, dip coating, printing, tape casting, slip casting, or any combination of the foregoing.

Clause 5. The method of any clause or example herein, in particular, any one of Clauses 1-4, wherein the heating element comprises a flexible membrane through which the electric current passes, and the providing of (b) comprises:
disposing the flexible membrane in contact with the one or more first precursors; or
disposing the flexible membrane such that each portion of the flexible membrane is spaced from a respective facing portion of the component surface by a substantially constant distance.

Clause 6. The method of any clause or example herein, in particular, any one of Clauses 1-5, wherein the heating element is formed of conductive carbon.

Clause 7. The method of any clause or example herein, in particular, Clause 6, wherein the heating element comprises a carbon felt, a graphite felt, a carbon film, a graphite film, a carbon nanotube film, or any combination of the foregoing.

Clause 8. The method of any clause or example herein, in particular, any one of Clauses 1-5, wherein the heating element is formed of metal or carbide.

Clause 9. The method of any clause or example herein, in particular, any one of Clauses 1-8, further comprising, after (c), removing the heating element away from or with respect to the component.

Clause 10. The method of any clause or example herein, in particular, any one of Clauses 1-6, wherein the heating element comprises a conductive carbon film, and the providing of (b) comprises forming the conductive carbon film on the one or more first precursors.

Clause 11. The method of any clause or example herein, in particular, any one of Clauses 1-7, 9, and 10, wherein the heating element comprises carbon black, carbon nanotubes, graphite, or any combination of the foregoing.

Clause 12. The method of any clause or example herein, in particular, any one of Clauses 1-11, wherein a thickness of the heating element is less than or equal to 1 mm.

Clause 13. The method of any clause or example herein, in particular, any one of Clauses 1-12, wherein a resistivity of the heating element is in a range of 0.02-1 Ω·m, inclusive.

Clause 14. The method of any clause or example herein, in particular, any one of Clauses 10-13, further comprising, after (c), heating the conductive carbon film in an oxygen atmosphere so as to convert the carbon film to vapor.

Clause 15. The method of any clause or example herein, in particular, Clause 14, wherein the heating to burn away the carbon film is at a temperature of 1000° C. or less, or at a temperature less than the sintering temperature.

Clause 16. The method of any clause or example herein, in particular, any one of Clauses 1-15, wherein the sintering of (c) is performed in an inert gas environment or vacuum environment.

Clause 17. The method of any clause or example herein, in particular, any one of Clauses 1-16, wherein the component is a metal, metal alloy, metal oxide, ceramic matrix composite, or any combination of the foregoing.

Clause 18. The method of any clause or example herein, in particular, any one of Clauses 1-17, wherein the component is formed of a refractory high-entropy superalloy.

Clause 19. The method of any clause or example herein, in particular, any one of Clauses 1-18, wherein the component comprises silicon carbide (SiC), niobium (Nb), hafnium (Hf), titanium (Ti), molybdenum (Mo), silicon (Si), boron (B), alumina (Al₂O₃), or any combination or alloy of the foregoing.

Clause 20. The method of any clause or example herein, in particular, any one of Clauses 1-19, wherein the component is formed of an alloy or cermet comprising SiC, Mo—Si—B alloy, Nb-silicide, C103 alloy, alumina, or nickel-based superalloy.

Clause 21. The method of any clause or example herein, in particular, any one of Clauses 1-20, wherein the component surface has a non-planar or contoured shape.

Clause 22. The method of any clause or example herein, in particular, any one of Clauses 1-21, wherein the component is a part for a gas-turbine engine.

Clause 23. The method of any clause or example herein, in particular, any one of Clauses 1-22, wherein the component is a turbine blade or combustor.

Clause 24. The method of any clause or example herein, in particular, any one of Clauses 1-23, wherein the first layer comprises or is a layer of a coating constructed to withstand and protect the component from environment temperatures of at least 1300° C.

Clause 25. The method of any clause or example herein, in particular, any one of Clauses 1-24, wherein the first layer comprises or is a layer of a coating constructed to withstand and protect the component from gas and environment temperatures of about 1700° C.

Clause 26. The method of any clause or example herein, in particular, any one of Clauses 1-25, further comprising:
after (a) and prior to (b), providing one or more second precursors over the surface of the component,
wherein the sintering of (c) comprises simultaneously sintering the one or more second precursors to form a second layer, the first layer being between the component surface and the second layer along a direction substantially perpendicular to the component surface.

Clause 27. The method of any clause or example herein, in particular, Clause 26, wherein the first and second layers formed by (c) comprise or are layers of an environmental-thermal barrier (ETB) coating, an environmental barrier coating, or a bond coat.

Clause 28. The method of any clause or example herein, in particular, any one of Clauses 26-27, further comprising:
after (a) and prior to (b), providing one or more third precursors over the surface of the component,
wherein the sintering of (c) comprises simultaneously sintering the one or more third precursors to form a third layer, the second layer being between the first layer and the third layer along the direction substantially perpendicular to the component surface.

Clause 29. The method of any clause or example herein, in particular, Clause 28, wherein the first, second, and third layers formed by (c) comprise or are layers of an environmental-thermal barrier (ETB) coating, an environmental barrier coating, or a bond coat.

Clause 30. The method of any clause or example herein, in particular, any one of Clauses 26-29, further comprising:
after (a) and prior to (b), providing one or more fourth precursors over the surface of the component,
wherein the sintering of (c) comprises simultaneously sintering the one or more fourth precursors to form a fourth layer, the third layer being between the second layer and the fourth layer along a direction substantially perpendicular to the component surface.

Clause 31. The method of any clause or example herein, in particular, Clause 30, wherein the first, second, third, and fourth layers formed by (c) comprise or are layers of an environmental-thermal barrier (ETB) coating, an environmental barrier coating, or a bond coat.

Clause 32. The method of any clause or example herein, in particular, any one of Clauses 1-25, further comprising:
after (c), providing one or more second precursors over the first layer; and
sintering the one or more second precursors to form a second layer by subjecting the one or more second precursors to a sintering temperature in a range of 500-3273 K, inclusive, for a duration of less than or equal to 10 minutes,
wherein the sintering temperature is generated by passing an electric current through the heating element to cause Joule heating of the heating element, and
the first layer is between the component surface and the second layer along a direction substantially perpendicular to the component surface.

Clause 33. The method of any clause or example herein, in particular, Clause 32, wherein the first and second layers comprise or are layers of an environmental-thermal barrier (ETB) coating, an environmental barrier coating, or a bond coat.

Clause 34. The method of any clause or example herein, in particular, any one of Clauses 32-33, further comprising:
after (c), providing one or more third precursors over the second layer; and
sintering the one or more third precursors to form a third layer by subjecting the one or more third precursors to a sintering temperature in a range of 500-3273 K, inclusive, for a duration of less than or equal to 10 minutes,
wherein the sintering temperature is generated by passing an electric current through the heating element to cause Joule heating of the heating element, and
the second layer is between the first layer and the third layer along the direction substantially perpendicular to the component surface.

Clause 35. The method of any clause or example herein, in particular, Clause 34, wherein the first, second, and third layers comprise or are layers of an environmental-thermal barrier (ETB) coating, an environmental barrier coating, or a bond coat.

Clause 36. The method of any clause or example herein, in particular, any one of Clauses 34-36, further comprising:
after (c), providing one or more fourth precursors over the third layer; and
sintering the one or more fourth precursors to form a fourth layer by subjecting the one or more fourth precursors to a sintering temperature in a range of 500-3273 K, inclusive, for a duration of less than or equal to 10 minutes,
wherein the sintering temperature is generated by passing an electric current through the heating element to cause Joule heating of the heating element, and
the third layer is between the second layer and the fourth layer along the direction substantially perpendicular to the component surface.

Clause 37. The method of any clause or example herein, in particular, Clause 36, wherein the first, second, third, and fourth layers comprise or are layers of an environmental-thermal barrier (ETB) coating, an environmental barrier coating, or a bond coat.

Clause 38. The method of any clause or example herein, in particular, any one of Clauses 1-37, wherein the first layer is formed on and in contact with the component surface, the component comprises silicon carbide (SiC), and the first layer comprises mullite, yttrium disilicate (YDS), hafnium silicate (Hf₄SiO₄), yttrium phosphate (YPO₄), or any combination of the foregoing.

Clause 39. The method of any clause or example herein, in particular, any one of Clauses 26-38, wherein:
(i) the second layer is formed on and in contact with the first layer, and the second layer comprises yttrium monosilicate (YMS), YDS, mullite, α-alumina, or any combination of the foregoing;
(ii) the third layer is formed on and in contact with the second layer, and the third layer comprises YMS;
(iii) the fourth layer is formed on and in contact with the third layer, and the fourth layer comprises gadolinium zirconate (Gd₂Zr₂O₇), yttria (Y₂O₃), ytterbium oxide (Yb₂O₃), or any combination of the foregoing; or
(iv) any combination of (i)-(iii).

Clause 40. The method of any clause or example herein, in particular, any one of Clauses 1-39, wherein the first layer is formed on and in contact with the component surface, the component comprises a C103 alloy, and the first layer comprises niobium silicide (NbSi₂).

Clause 41. The method of any clause or example herein, in particular, Clause 40, wherein:
(i) the second layer is formed on and in contact with the first layer, and the second layer comprises α-alumina, mullite, barium zirconate (BaZrO₃), Er₄Hf₃O₁₂, yttrium monosilicate (YMS), or any combination of the foregoing;
(ii) the third layer is formed on and in contact with the second layer, and the third layer comprises YMS;
(iii) the fourth layer is formed on and in contact with the third layer, and the fourth layer comprises gadolinium zirconate (Gd₂Zr₂O₇), yttria (Y₂O₃), ytterbium oxide (Yb₂O₃), or any combination of the foregoing; or
(iv) any combination of (i)-(iii).

Clause 42. The method of any clause or example herein, in particular, any one of Clauses 1-39, wherein the first layer is formed on and in contact with the component surface, the component comprises alumina, and the first layer comprises yttrium aluminum perovskite (YAP), yttrium aluminum garnet (YAG), barium zirconate (BaZrO₃), yttrium phosphate (YbPO₄), yttrium monosilicate (YMS), Er₄Hf₃O₁₂, ytterbium oxide (Yb₂O₃), mullite, gadolinium zirconate (Gd₂Zr₂O₇), or any combination of the foregoing.

Clause 43. The method of any clause or example herein, in particular, Clause 42, wherein the second layer is formed on and in contact with the first layer, and the second layer comprises YMS.

Clause 44. The method of any clause or example herein, in particular, any one of Clauses 1-43, wherein the first layer is a bond layer and is metallic or intermetallic.

Clause 45. The method of any clause or example herein, in particular, any one of Clauses 26-44, wherein one of the first through fourth layers of the ETB coating has a porosity less than that of at least another of the first through fourth layers of the ETB coating.

Clause 46. The method of any clause or example herein, in particular, any one of Clauses 1-45, wherein the respective providing of one or more precursors comprises spray coating, dip coating, printing, tape casting, slip casting, or any combination of the foregoing.

Clause 47. The method of any clause or example herein, in particular, any one of Clauses 1-46, wherein each sintering is performed in an inert gas environment or vacuum environment.

Clause 48. The method of any clause or example herein, in particular, any one of Clauses 1-47, wherein the one or more first precursors comprise γ-alumina, and the first layer is formed of α-alumina.

Clause 49. The method of any clause or example herein, in particular, any one of Clauses 1-47, wherein the one or more first precursors comprise cobalt oxide (CoO) and alumina, and the first layer is formed of CoAl₂O₄.

Clause 50. The method of any clause or example herein, in particular, any one of Clauses 1-47, wherein the first layer is formed as a two-phase material.

Clause 51. The method of any clause or example herein, in particular, Clause 50, wherein the two-phase material is an yttria-stabilized zirconia (YSZ) and alumina two-phase material, or a zirconia and mullite two-phase material.

Clause 52. The method of any clause or example herein, in particular, any one of Clauses 1-51, wherein:
the providing of (b) is such that a portion of the component is exposed from the heating element, and
the method further comprises, during the sintering of (c), passively or actively cooling the component via the exposed portion.

Clause 53. The method of any clause or example herein, in particular, any one of Clauses 1-52, wherein a coefficient of thermal expansion for the first layer is substantially the same as that of the component surface.

Clause 54. A component with a coating formed thereon by the method of any clause or example herein, in particular, any one of Clauses 1-53.

Clause 55. The component of any clause or example herein, in particular, Clause 54, wherein:
the coating is an environmental-thermal barrier (ETB) coating, an environmental barrier coating, or a bond coat; and/or
the component is configured as a part for a gas-turbine engine (e.g., turbine blade or combustor).

### Conclusion

Any of the features illustrated or described herein, for example, with respect to FIGS. 1A-8D and Clauses 1-55, can be combined with any other feature illustrated or described herein, for example, with respect to FIGS. 1A-8D and Clauses 1-55 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
(a) providing one or more first precursors over a surface of a component to be coated;
(b) providing a heating element over the one or more first precursors, the heating element substantially conforming to a shape of the component surface; and
(c) sintering the one or more first precursors to form a first layer of an environmental-thermal barrier (ETB) coating over the component surface by subjecting the one or more first precursors to a sintering temperature in a range of 500-3273 K, inclusive, for a duration of less than or equal to 10 minutes,
wherein the sintering temperature is generated by passing an electric current through the heating element to cause Joule heating of the heating element.

2. (canceled)

3. The method of claim 1, wherein the heating element comprises a flexible membrane through which the electric current passes, and the providing of (b) comprises:
disposing the flexible membrane in contact with the one or more first precursors; or
disposing the flexible membrane such that each portion of the flexible membrane is spaced from a respective facing portion of the component surface by a substantially constant distance.

4-6. (canceled)

7. The method of claim 1, wherein the heating element comprises a conductive carbon film, and the providing of (b) comprises forming the conductive carbon film on the one or more first precursors.

8-9. (canceled)

10. The method of claim 1, wherein:
a thickness of the heating element is less than or equal to 1 mm;
a resistivity of the heating element is in a range of 0.02-1 Ω·m, inclusive; or
both of the above.

11. The method of claim 7, further comprising, after (c), heating the conductive carbon film in an oxygen atmosphere so as to convert the carbon film to vapor.

12-13. (canceled)

14. The method of claim 1, wherein the component is a metal, metal alloy, metal oxide, ceramic matrix composite, or any combination of the foregoing.

15. (canceled)

16. The method of claim 1, wherein the component comprises silicon carbide (SiC), niobium (Nb), hafnium (Hf), titanium (Ti), molybdenum (Mo), silicon (Si), boron (B), alumina (Al₂O₃), or any combination or alloy of the foregoing.

17. (canceled)

18. The method of claim 1, wherein the component surface has a non-planar or contoured shape.

19. (canceled)

20. The method of claim 1, wherein the component is a turbine blade or combustor for a gas-turbine engine.

21. The method of claim 1, wherein the ETB coating is constructed to withstand and protect the component from environment temperatures of at least 1300° C.

22. (canceled)

23. The method of claim 1, further comprising:
after (a) and prior to (b), providing one or more second precursors over the surface of the component,
wherein the sintering of (c) comprises simultaneously sintering the one or more second precursors to form a second layer of the ETB coating, the first layer being between the component surface and the second layer along a direction substantially perpendicular to the component surface.

24-25. (canceled)

26. The method of claim 1, further comprising:
after (c), providing one or more second precursors over the first layer; and
sintering the one or more second precursors to form a second layer of the ETB coating by subjecting the one or more second precursors to a sintering temperature in a range of 500-3273 K, inclusive, for a duration of less than or equal to 10 minutes,
wherein the sintering temperature is generated by passing an electric current through the heating element to cause Joule heating of the heating element, and
the first layer is between the component surface and the second layer along a direction substantially perpendicular to the component surface.

27-34. (canceled)

35. The method of claim 1, wherein the first layer is a bond layer and is metallic or intermetallic.

36-38. (canceled)

39. The method of claim 1, wherein the one or more first precursors comprise γ-alumina, and the first layer is formed of α-alumina.

40. The method of claim 1, wherein the one or more first precursors comprise cobalt oxide (CoO) and alumina, and the first layer is formed of CoAl₂O₄.

41-45. (canceled)

46. A structure comprising:
a component for a gas-turbine engine; and
one or more coatings formed over a surface of the component, wherein the one or more coatings comprise an environmental-thermal barrier coating, an environmental barrier coating, or a bond coat.

47. The structure of claim 46, wherein the component comprises a turbine blade or combustor.

48. The structure of claim 46, wherein the one or more coatings comprise:
a first layer formed on and in contact with the component surface, the component comprises silicon carbide (SiC), and the first layer comprises mullite, yttrium disilicate (YDS), hafnium silicate (Hf₄SiO₄), yttrium phosphate (YPO₄), or any combination of the foregoing;
a second layer formed on and in contact with the first layer, and the second layer comprises yttrium monosilicate (YMS), YDS, mullite, α-alumina, or any combination of the foregoing;
a third layer formed on and in contact with the second layer, and the third layer comprises YMS; and
a fourth layer formed on and in contact with the third layer, and the fourth layer comprises gadolinium zirconate (Gd₂Zr₂O₇), yttria (Y₂O₃), ytterbium oxide (Yb₂O₃), or any combination of the foregoing.

49. The structure of claim 46, wherein the one or more coatings comprise:
a first layer formed on and in contact with the component surface, the component comprises a C103 alloy, and the first layer comprises niobium silicide (NbSi₂);
a second layer formed on and in contact with the first layer, and the second layer comprises α-alumina, mullite, barium zirconate (BaZrO₃), Er₄Hf₃O₁₂, yttrium monosilicate (YMS), or any combination of the foregoing;
a third layer formed on and in contact with the second layer, and the third layer comprises YMS; and
a fourth layer formed on and in contact with the third layer, and the fourth layer comprises gadolinium zirconate (Gd₂Zr₂O₇), yttria (Y₂O₃), ytterbium oxide (Yb₂O₃), or any combination of the foregoing.

50. The structure of claim 46, wherein the one or more coatings comprise:
a first layer formed on and in contact with the component surface, the component comprises alumina, and the first layer comprises yttrium aluminum perovskite (YAP), yttrium aluminum garnet (YAG), barium zirconate (BaZrO₃), yttrium phosphate (YbPO₄), yttrium monosilicate (YMS), Er₄Hf₃O₁₂, ytterbium oxide (Yb₂O₃), mullite, gadolinium zirconate (Gd₂Zr₂O₇), or any combination of the foregoing; and
a second layer formed on and in contact with the first layer, and the second layer comprises YMS.
